(19) United States
(12) Patent Application Publication
(10) Pub. No.: US 2005/0037643 A1
(43) Pub. Date: Feb. 17, 2005

(54) Electronic device and the keyboard thereof

(76) Inventor: Chien-Sheng Lo, Taipei (TW)

Correspondence Address: BIRCH STEWART KOLASCH & BIRCH, PO BOX 747, FALLS CHURCH, VA, 22040-0747, US

(21) Appl. No.: 10/924,997

(22) Filed: Aug. 25, 2004

(30) Foreign Application Priority Data
Sep. 1, 2003 (TW) 092124101

(51) Int. Cl. H01R 12/00

(52) U.S. Cl. 439/77

(57) ABSTRACT

An electronic device includes a case with an opening, a main circuit board and a keyboard assembly. The main circuit board is located in the case and has at least one first coupling point. The keyboard assembly covers the opening to couple with the case and has at least one second coupling point fixedly located thereon. When the keyboard assembly is coupled with the case, the second coupling point corresponds and connects to the first coupling point to establish signal connection.

### FIELD OF THE INVENTION

The present invention relates to a keyboard assembly and particularly to a keyboard assembly that connects to an electronic device through coupling points to facilitate installation and removing.

### BACKGROUND OF THE INVENTION

In conventional techniques, a keyboard and an electronic device may be connected in many different ways to establish signal connection. One of the ways is to extend a portion of a flexible flat cable from the keyboard for inserting into a connector in the device to establish signal connection. The length and size of the flat cable vary depending on different requirements. It may be a symmetrical or asymmetrical structure. Such a design is frequently used in the present notebook computers.

Refer to FIG. 1 for an electronic device 1 equipped with a keyboard. It includes a case 11 and a keyboard 20. The keyboard 20 has a flexible flat cable 22 which has a portion extending outwards. The flat cable 22 may be inserted in a connector 15 located in the case 11 to enable the keyboard 20 to be connected to the electronic device 1 and establish signal connection and communication.

The foregoing design is inconvenient during assembly and removing of the keyboard, notably:

1. At the assembly stage operators have to pull the flat cable 22 to the connector 15 for coupling. The case 11 usually has a space constraint that might hinder operations.

2. The flat cable 22 requires tending. Too long of the cable will interfere other elements, while too short of the cable makes assembly difficult.

3. For doing inspection and repairs, maintenance people and users have to unfasten the connector 15 from the case 11. This process often results in loosening of the connector 15 and wearing of the flat cable 22. It is also not convenient.

### SUMMARY OF THE INVENTION

Therefore the primary object of the invention is to provide an electronic device with a keyboard that does not need cable tending, may shorten assembly time and speed up keyboard assembly and disassembly, and facilitate repairs and maintenance for technicians and users.

In order to achieve the foregoing object, the invention provides an electronic device that includes a case, a main circuit board, and a keyboard assembly. The case has an opening. The keyboard assembly covers the opening when it is assembled with the case. The main circuit board is located in the case and has at least one first coupling point. The keyboard has at least one fixed second coupling point. When the keyboard assembly and the case are assembled, the second coupling point corresponds to and connects the first coupling point to establish signal connection.

The keyboard assembly includes at least one key top, at least one button key support structure and one keyboard circuit board. The button key support structure is located between the keyboard circuit board and the key top to brace the key top. When the key top is depressed, the button key support structure is deformed locally. When the pressure is released, the button key support structure returns to its original form and pushes the key top to its original elevation. When the key top is depressed, the keyboard circuit board issues an electric signal which is transmitted through the second coupling point and first coupling point to the main circuit board.

In one preferred embodiment, the keyboard circuit board is a flexible flat cable. The keyboard circuit board has a bracing base plate located thereunder. The flat cable has an extension extending over the bracing base plate and being folded and anchored on a lower side of the bracing base plate. The second coupling point is located in the extension area corresponding and connecting to the first coupling point.

In another preferred embodiment, the keyboard circuit board is a hard circuit board. The keyboard circuit board has a bracing base plate located thereunder. The bracing base plate has an opening. The second coupling point is located in the opening to correspond and connect to the first coupling point.

In yet another preferred embodiment, the keyboard circuit board is a hard and thick circuit board with sufficient rigidity to brace the key top, button key support structure and keyboard circuit section. The second coupling point is located on a lower surface of the hard circuit board corresponding to the first coupling point to establish electric connection.

In still another preferred embodiment, the first coupling point is an elastic reed connecting to an elastic reed connector on the main circuit board, and the second coupling point is a conductive zone exposed on the keyboard circuit section.

In another preferred embodiment, the first coupling point is a conductive zone exposed on the main circuit board, and the second coupling point is an elastic reed connecting to an elastic reed connector on the keyboard circuit section.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional keyboard and main circuit board in a connecting condition.

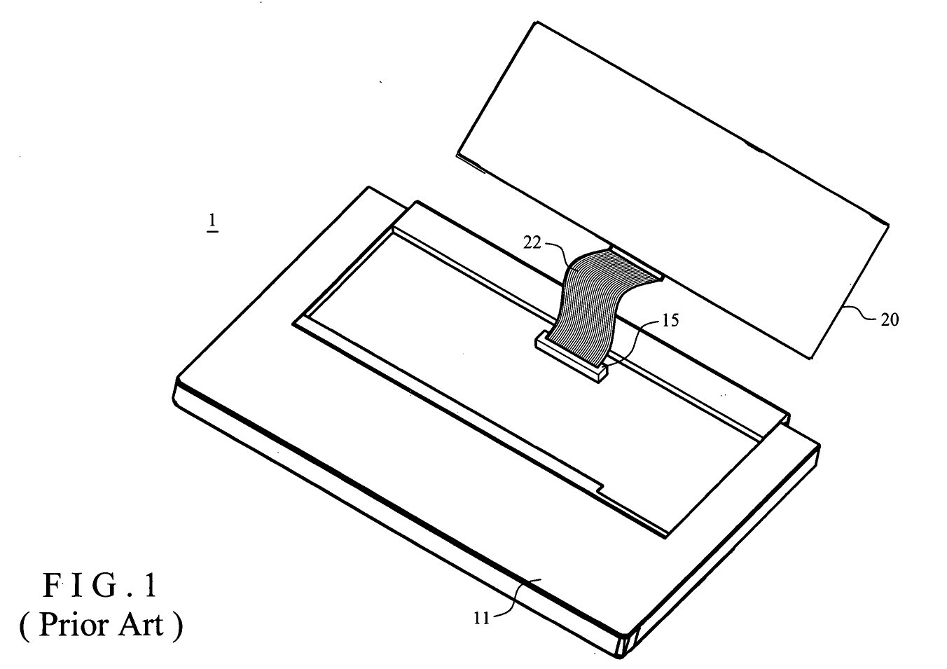

FIG. 2 is a perspective view of an electronic device according to the invention.

FIG. 3 is a schematic view of a case and a main circuit board of an electronic device.

FIG. 4 is an exploded view of an embodiment of the keyboard of the invention with the keyboard circuit section made from a flexible flat cable.

FIG. 5 is a schematic view of an embodiment of the invention with the keyboard assembly installed in a case, and the keyboard circuit section made from a flexible flat cable.

FIG. 6 is a schematic view of an embodiment of the keyboard with the keyboard circuit section made from a flexible flat cable.

FIG. 7 is an exploded view of another embodiment of the keyboard of the invention with the keyboard circuit section made from a hard circuit board.

FIG. 8 is a schematic view of another embodiment of the keyboard with the keyboard circuit section made from a hard circuit board.

FIG. 9 is an exploded view of another embodiment of the keyboard of the invention with the keyboard circuit section made from a hard and thick circuit board.

FIG. 10 is a schematic view of another embodiment of the keyboard with the keyboard circuit made from a hard and thick circuit board.

FIG. 11 is an exploded view of another embodiment of the keyboard of the invention with the first coupling point including a plurality of small conductive zones and the second coupling point an elastic reed of a second connector fixed on the keyboard circuit section made from a flexible flat cable.

FIG. 12 is an exploded view of another embodiment of the keyboard of the invention with the first coupling point including a plurality of small conductive zones and the second coupling point an elastic reed of a second connector fixed on the keyboard circuit section made from a hard circuit board.

FIG. 13 is an exploded view of another embodiment of the keyboard of the invention with the first coupling point including a plurality of small conductive zones and the second coupling point an elastic reed of a second connector fixed on the keyboard circuit section made from a hard and thick circuit board with a great rigidity.

### DESCRIPTION OF THE PREFERRED EMBODIMENTS

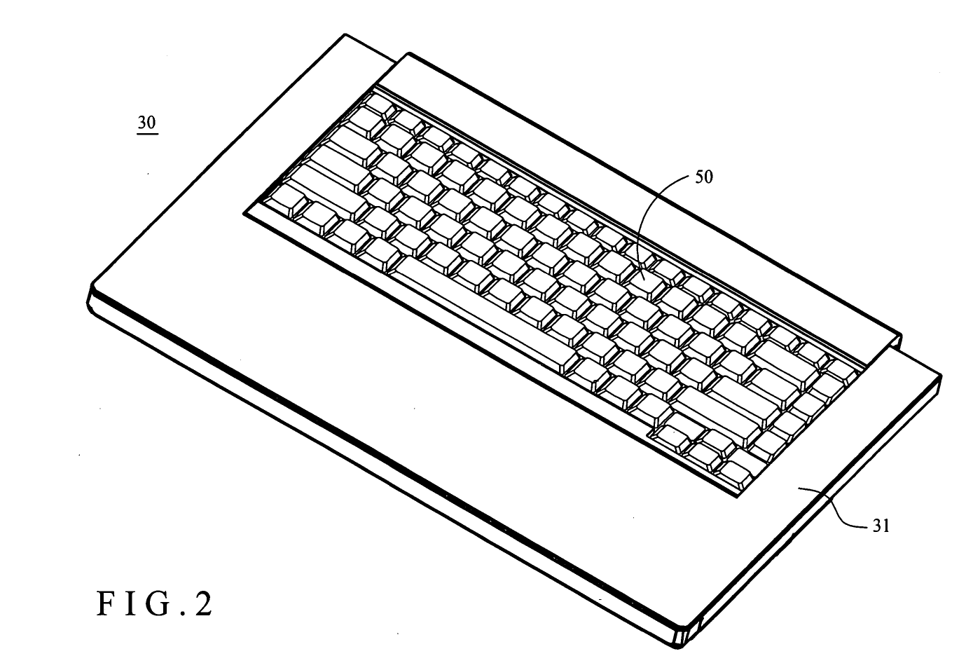

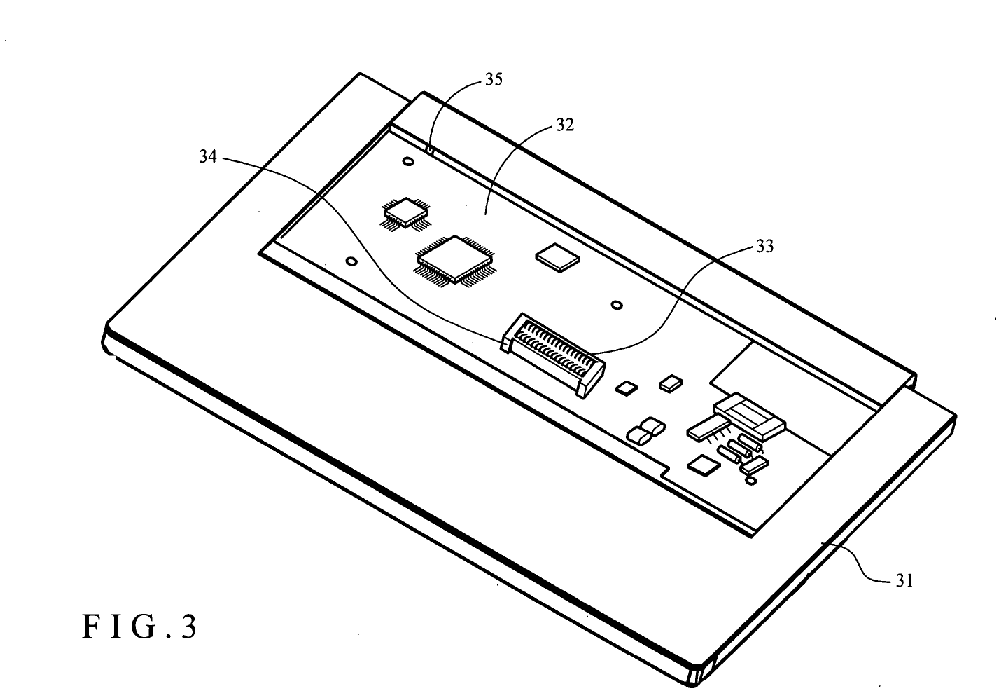

Referring to FIGS. 2 and 3, the electronic device 30 includes a case 31, a main circuit board 32 and a keyboard assembly 50. The case 31 has an opening 35. The keyboard assembly 50 is located on the opening 35 of the case 31. The main circuit board 32 is located in the case 31. There is a first connector 34 located on the main circuit board 32. The first connector 34 has at least one first coupling point 33 which is elastic and may be locally deformed under pressure. Once the pressure is released, it returns to the original form.

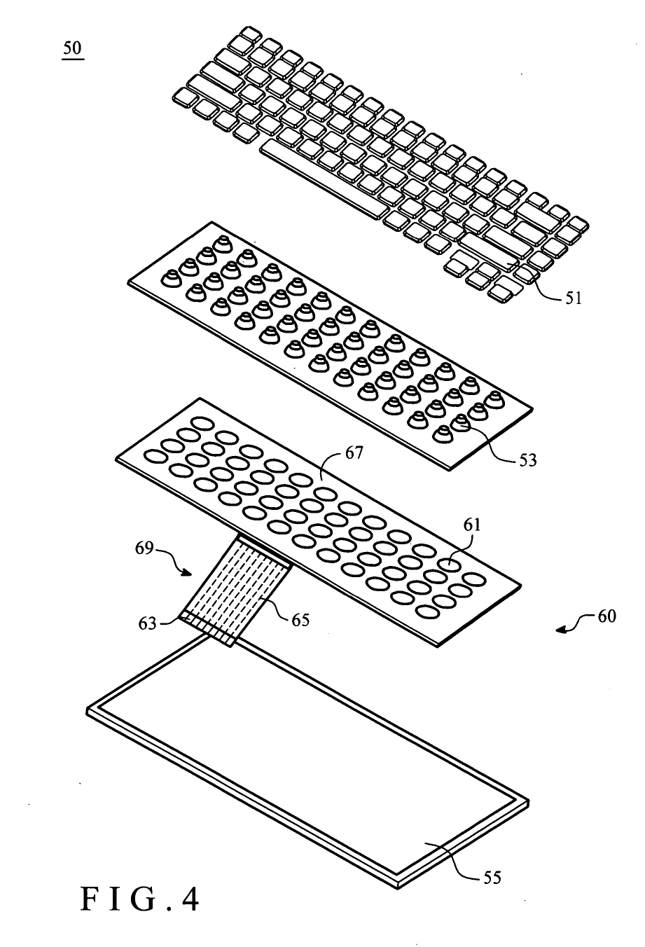

Referring to FIG. 4, the keyboard assembly 50 includes at least one key top 51, one keyboard support structure 53 and one keyboard circuit section 60. Depressing each key top 51 represents a different signal input. Each key top 51 has a corresponding button key support structure 53 to brace and anchor the key top 51. When the key top 51 is depressed, the button key structure 53 deforms locally. When the pressure is released, the button key structure 53 returns to its original form and pushes the key top 51 to its original elevation.

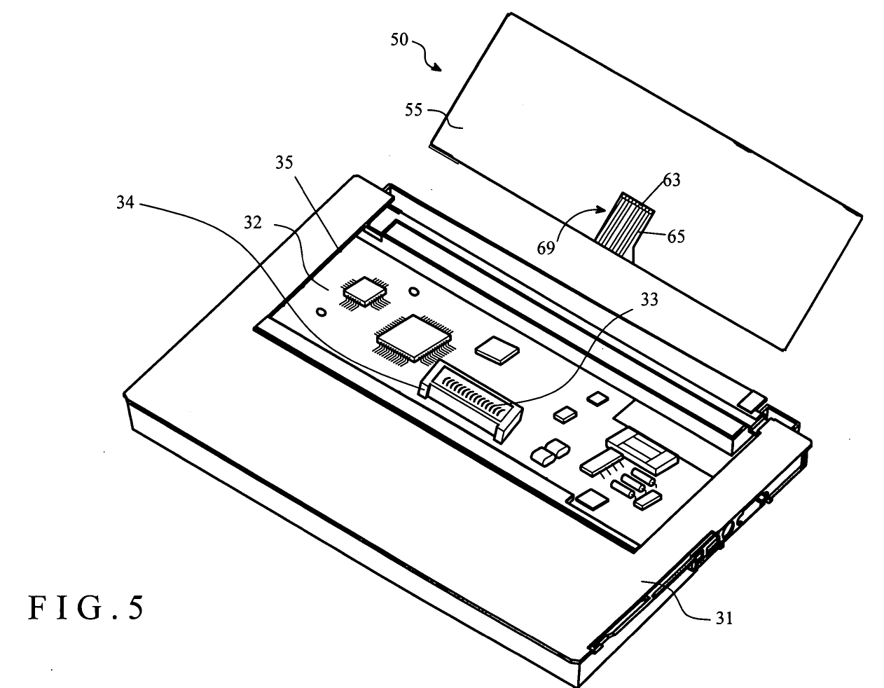

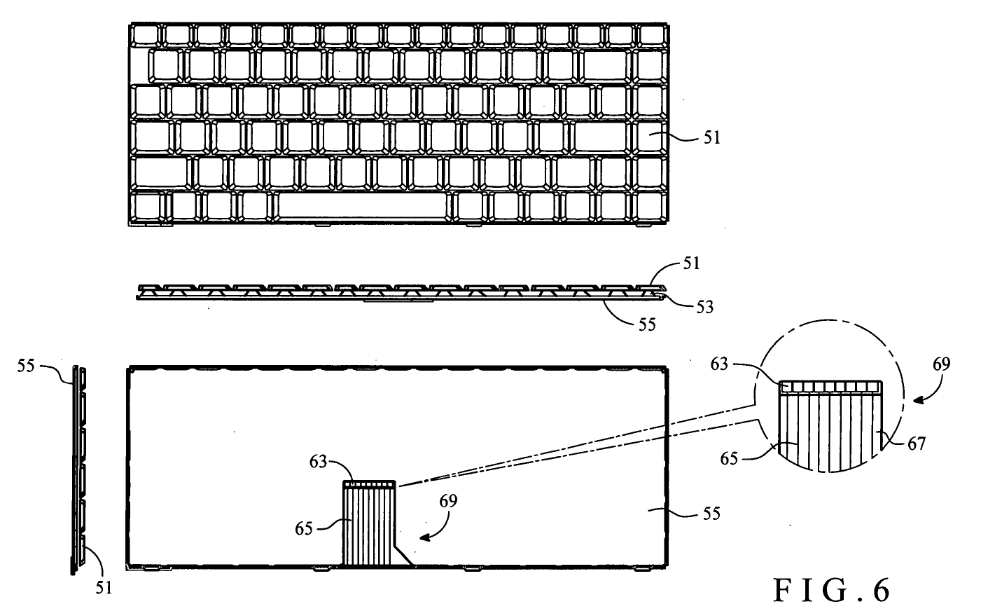

Referring to FIGS. 4, 5 and 6, the keyboard circuit section 60 is located below the button key support structure 53. It includes at least one button key contact point 61, at least one second coupling point 63, one signal transmission line 65 and one insulation substance 67.The button key contact point 61 includes a plurality of small conductive zones located and exposed on the surface of the insulation substance 67, and on a location corresponding to each key top 51. When the key top 51 and the button key support structure 53 are depressed and hit the button key contact point 61, an electric signal is issued to represent the electric signal of the key top 51.

The second coupling point 63 corresponds and electrically connects to the first coupling point 33. The insulation substance 67 is located in a non-conductive area in the keyboard circuit section 60 to prevent short circuit from occurring between the signal transmission line 65 and external objects. The signal transmission line 65 is embedded in the insulation substance 67 and protected. The signal transmission line 65 is connected to each button key contact point 61 and the second coupling point 63 to transmits electric signals from the button key contact point 61 to the second coupling point 63.

Refer to FIGS. 4, 5 and 6 for a preferred embodiment. The keyboard circuit section 60 is made from a flexible flat cable. As it is flexible, it does not have enough rigidity and bracing power. Hence a bracing base plate 55 is provided under the keyboard circuit section 60 to support the key top 51, button key support structure 53 and keyboard circuit section 60. The keyboard circuit section 60 further has an extension 69 extending over the bracing base plate 53 and being folded and bonded to a lower side of the bracing plate 55. The second coupling point 63 is located on the extension 69 corresponding and electrically connecting to the first coupling point 33.

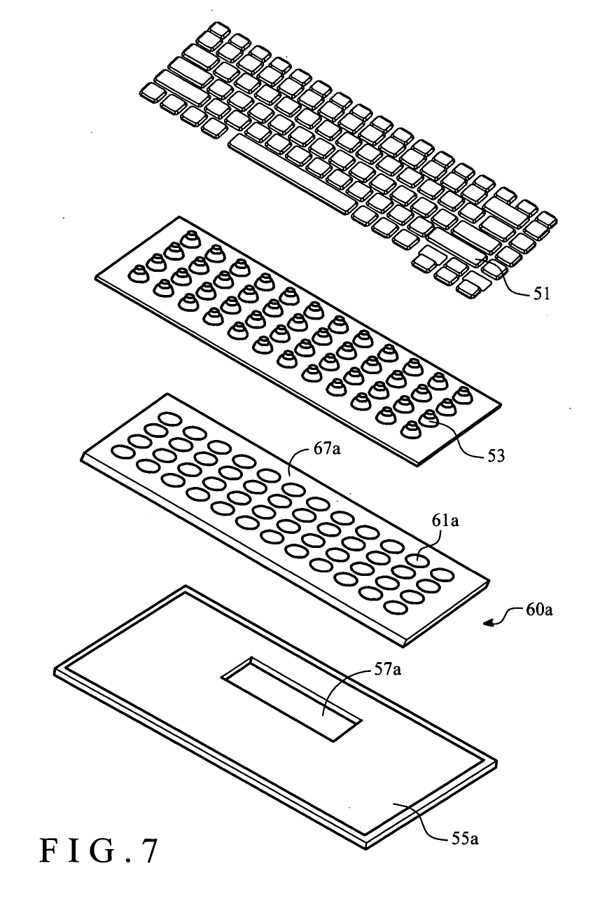

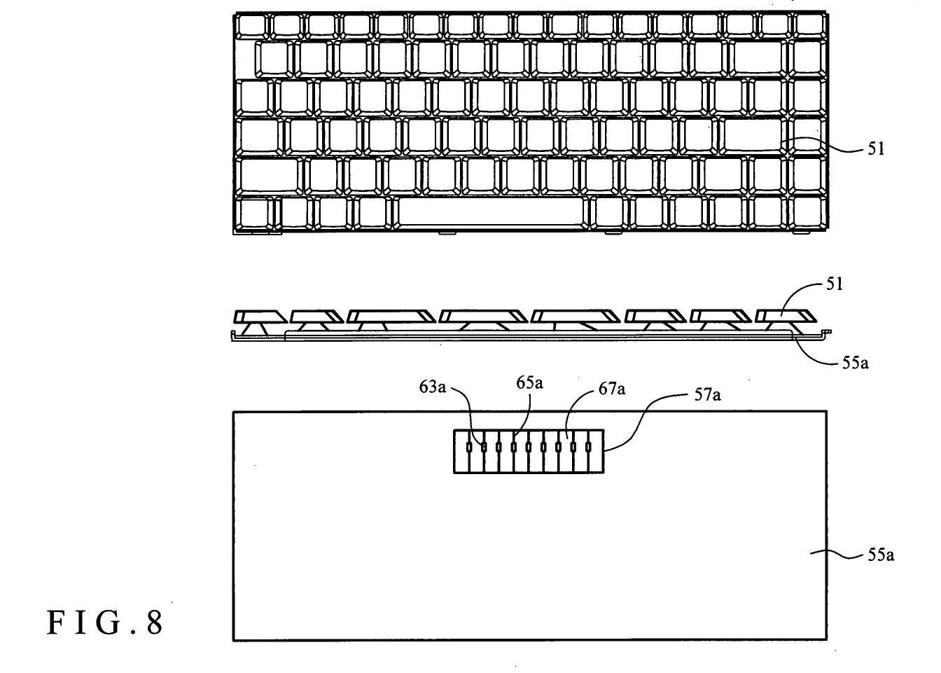

Refer to FIGS. 7 and 8 for another preferred embodiment. The keyboard circuit section 60a is made from a hard circuit board. A bracing base plate 55a is provided to increase the rigidity and support the key top 51, button key support structure 53 and keyboard circuit section 60a. The bracing base plate 55a has at least one opening 57a. A second coupling point 63a includes a plurality of small conductive zones located and exposed on a lower surface of the keyboard circuit section 60a and above the opening 57a. The second coupling point 63a corresponds and electrically connects to the first coupling point 33. Signal transmission lines 65a are embedded in an insulation substance 67a and protected. The signal transmission line 65a connects each button key contact point 61a and the second coupling point 63a to transmit electric signals from the button key contact point 61a to the second coupling point 63a.

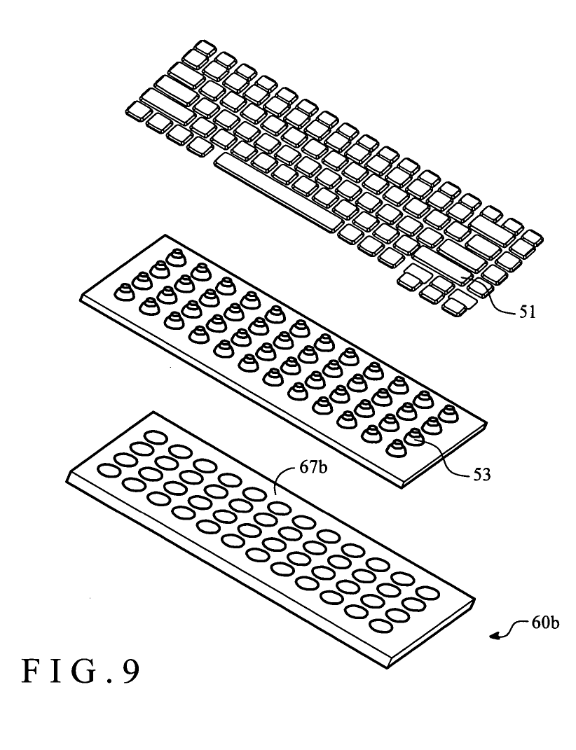

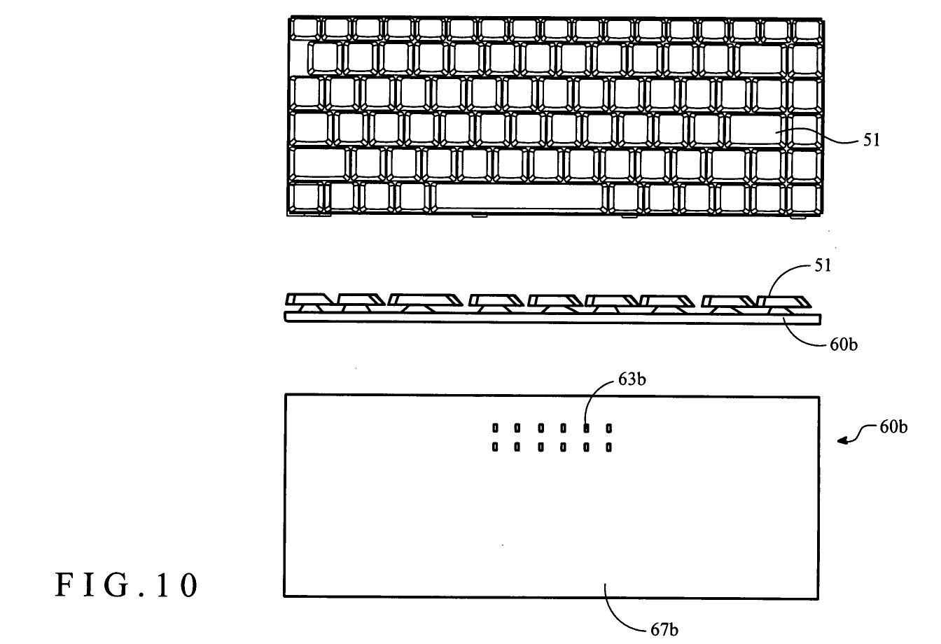

Refer to FIGS. 9 and 10 for yet another embodiment. The keyboard circuit section 60b is made from a hard and thick circuit board with enough rigidity to brace the key top 51, button key support structure 53 and keyboard circuit section 60b. The second coupling point 63b includes a plurality of small conductive zones located and exposed on a lower surface of an insulation substance 67b corresponding and electrically connecting to the first coupling point 33.

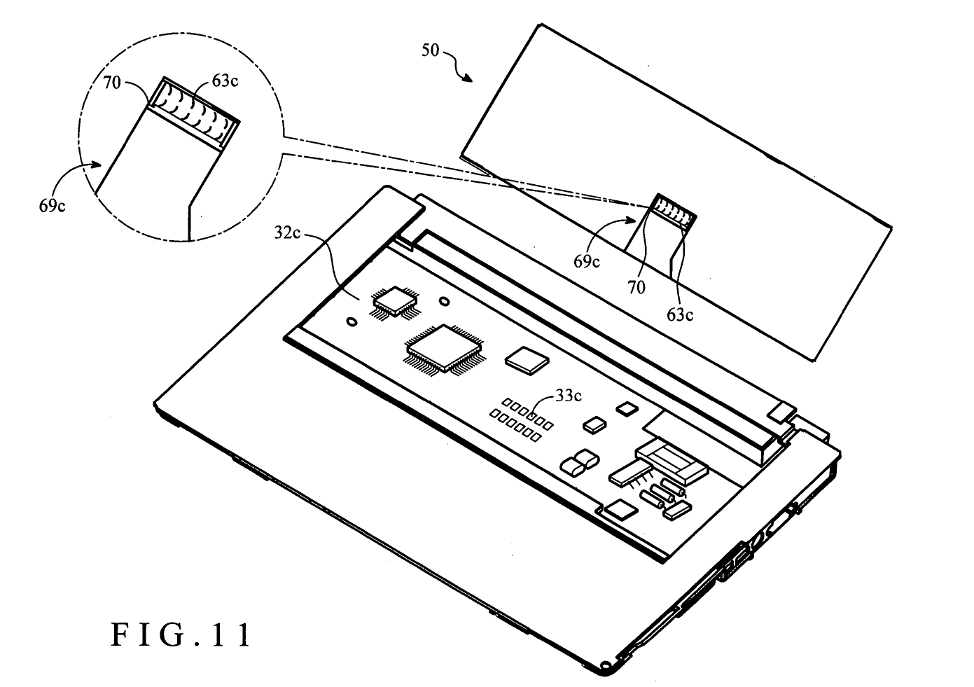

Refer to FIG. 11 for still another preferred embodiment. The first coupling point 33c includes a plurality of small conductive zones located and exposed on the surface of the main circuit board 32c. The second coupling point 63c is an elastic reed of a second connector 70 fixedly located on an extension 69c of a flexible flat cable. The first coupling point 33c corresponds and electrically connects to the second coupling point 63c.

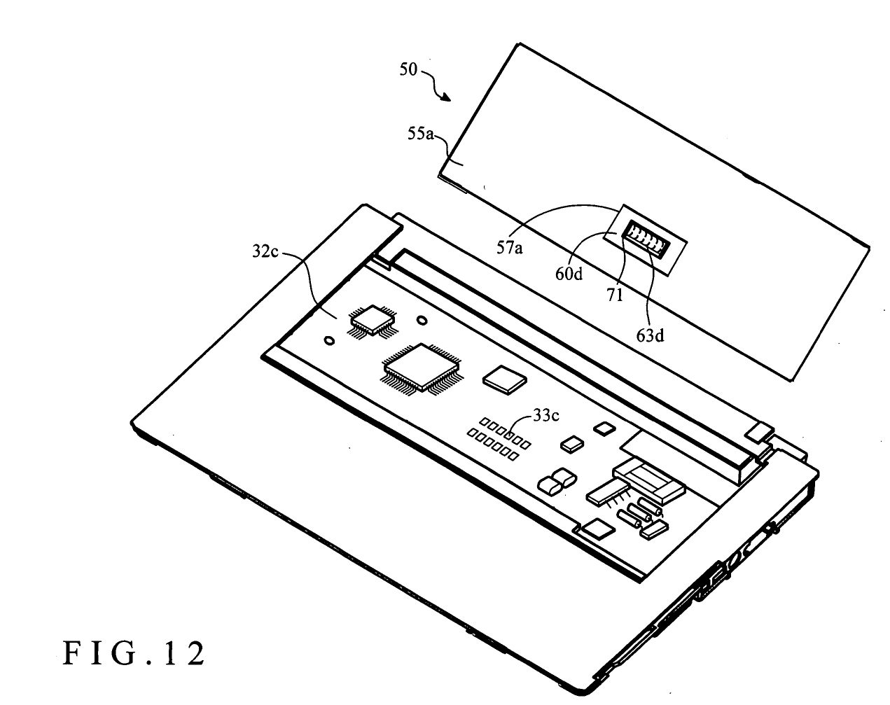

Refer to FIG. 12 for another preferred embodiment. The first coupling point 33c includes a plurality of small conductive zones located and exposed on the surface of the main circuit board 32c. The second coupling point 63c is an elastic reed of a third connector 71 fixedly located on a keyboard circuit section 60d made from a hard circuit board. A bracing base plate 55a is provided to increase the rigidity and brace the keyboard circuit section 60d. The bracing base plate 55a has at least one opening 57a. The second coupling point 63d is extended through the opening 57a. The first coupling point 33c corresponds and electrically connects to the second coupling point 63b.

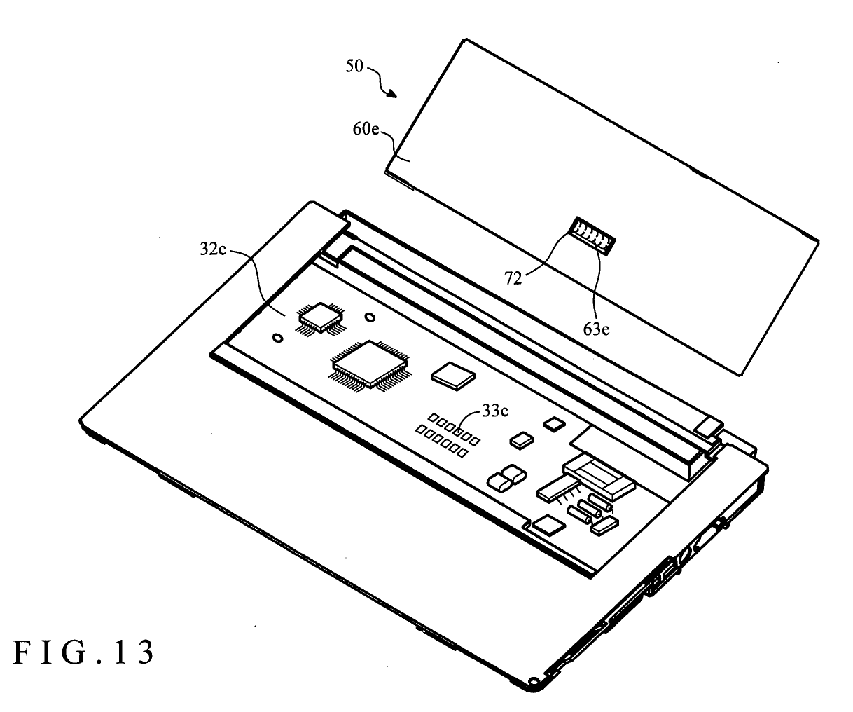

Refer to FIG. 13 for another preferred embodiment. The first coupling point 33c includes a plurality of small conductive zones located and exposed on the surface of the main circuit board 32c. The second coupling point 63e is an elastic reed of a fourth connector 72 fixedly located oil a keyboard circuit section 60e made from a hard and thick circuit board. The first coupling point 33c corresponds and electrically connects to the second coupling point 63b.

By means of the construction set forth above, during assembling and removing of the keyboard assembly 50, the flexible flat cable 22 needs not be inserted into the connector 15 as the conventional techniques do. By placing the keyboard assembly 50 at the opening 35 of the case 31, the second coupling point 63 can be in contact with the first coupling point 33 of the main circuit board 32 to establish electric connection. Thus the keyboard assembly 50 of the invention is easy to install and may save working time, and enables maintenance technicians and users to maintain and replace easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An electronic device, comprising:
a case having an opening;
a main circuit board located in the case having at least one first coupling point; and
a keyboard assembly covered the opening to couple with the case including at least one second coupling point which is fixedly located on the keyboard assembly, the second coupling point corresponding and connecting to the first coupling point when the keyboard assembly is coupled with the case to establish signal connection.

2. The electronic device of claim 1, wherein the first coupling point is an elastic reed of an elastic reed connector.

3. The electronic device of claim 1, wherein the first coupling point is a conductive zone exposed on the main circuit board.

4. The electronic device of claim 1, wherein the keyboard assembly includes:
at least a key top;
at least a button key support structure located between the keyboard circuit board and the key top for bracing the key top, the button key support structure being deformed locally when the key top is subject to a pressure, and the button key support structure returning to its original form and pushing the key top to its original elevation when the pressure is released;
a keyboard circuit board located below the button key support structure having at least one button key contact point corresponding to the key top such that when the key top is depressed the button key contact point issues an electric signal which is transmitted through the second coupling point and the first coupling point to the main circuit board;
a signal transmission line linking each button key contact point to the second coupling point for transforming input actions of users to electric signals for sending to the device; and
an insulation substance made from a non-conductive material located in the keyboard circuit section to prevent short circuit from occurring to the signal transmission line and external objects.

5. The electronic device of claim 4, wherein the keyboard circuit board is a flexible flat cable.

6. The electronic device of claim 4, wherein the keyboard circuit board is a hard circuit board.

7. The electronic device of claim 6, wherein the second coupling point is a conductive zone exposed on a lower surface of the hard circuit board corresponding and electrically connecting to the first coupling point.

8. The electronic device of claim 6, wherein the second coupling point is an elastic reed of an elastic reed connector connected to a lower surface of the hard circuit board to correspond and electrically connect to the first coupling point.

9. The electronic device of claim 4, wherein the keyboard assembly has a bracing base plate located below the keyboard circuit section to support and anchor the key top, the button key support structure and the keyboard circuit section.

10. The electronic device of claim 9, wherein the bracing base plate has an opening corresponding to the first coupling point to allow the first coupling point to connect to the second coupling point.

11. The electronic device of claim 9, wherein the keyboard circuit section is a flexible flat cable and has an extension extending over the bracing base plate to be folded and anchored on a lower side of the bracing base plate.

12. The electronic device of claim 11, wherein the extension is bonded to the lower side of the bracing base plate.

13. The electronic device of claim 11, wherein the second coupling point is a conductive zone exposed on the extension at a location corresponding to the first coupling point.

14. The electronic device of claim 11, wherein the second coupling point is an elastic reed of a second connector connected to the extension and at a location corresponding to the first coupling point.

15. A keyboard assembly located in an electronic device which has a case with an opening and a main circuit board located in the case, the main circuit board having at least one first coupling point, the keyboard assembly covering the opening to couple with the case and having at least one second coupling point fixedly located thereon,
wherein the second coupling point corresponds and connects to the first coupling point to establish signal connection when the keyboard assembly and the case are coupled.

16. The keyboard assembly of claim 15, wherein the first coupling point is an elastic reed of an elastic reed connector.

17. The keyboard assembly of claim 15, wherein the first coupling point is a conductive zone exposed on the main circuit board.

18. The keyboard assembly of claim 15 further including:
at least a key top;
at least a button key support structure located between the keyboard circuit board and the key top to support the key top, the button key support structure being deformed locally when the key top subject to a pressure and returning to its original form when the pressure is released and pushing the key top to its original elevation, wherein the keyboard circuit board having at least one button key contact point corresponding to the key top such that when the key top is depressed the button key contact point issues an electric signal which is transmitted through the second coupling point and the first coupling point to the main circuit board;
a signal transmission line linking each button key contact point to the second coupling point for transforming input actions of users to electric signals for sending to the device; and
an insulation substance made from a non-conductive material located in the keyboard circuit section to prevent short circuit from occurring to the signal transmission line and external objects.

19. The keyboard assembly of claim 18, wherein the keyboard circuit section is a flexible flat cable.

20. The keyboard assembly of claim 18, wherein the keyboard circuit section is a hard circuit board.

21. The keyboard assembly of claim 20, wherein the second coupling point is a conductive zone exposed on a lower surface of the hard circuit board to correspond and electrically connect to the first coupling point.

22. The keyboard assembly of claim 20, wherein the second coupling point is an elastic reed of an elastic reed connector connected to a lower surface of the hard circuit board to correspond and electrically connect to the first coupling point.

23. The keyboard assembly of claim 18 further having a bracing base plate located below the keyboard circuit section to support and anchor the key top, the button key support structure and the keyboard circuit section.

24. The keyboard assembly of claim 23, wherein the bracing base plate has an opening corresponding to the first coupling point to allow the first coupling point to connect to the second coupling point.

25. The keyboard assembly of claim 18, wherein the keyboard circuit section is a flexible flat cable and has an extension extending over the bracing base plate to be folded and anchored on a lower side of the bracing base plate.

26. The keyboard assembly of claim 25, wherein the extension is bonded to the lower side of the bracing base plate.

27. The keyboard assembly of claim 25, wherein the second coupling point is a conductive zone exposed on the extension at a location corresponding to the first coupling point.

28. The keyboard assembly of claim 25, wherein the second coupling point is an elastic reed of a second connector connected to the extension and at a location corresponding to the first coupling point.
